(19) United States
(12) Patent Application Publication
(10) Pub. No.: US 2002/0086198 A1
(43) Pub. Date: Jul. 4, 2002

(54) Electrically conducting curable composition and cured product thereof

(75) Inventors: Tadashi Ilno, Kanagawa (JP); Mitsuhiro Imaizumi, Kanagawa (JP); Ryutaro Fujihira, Kanagawa (JP); Makoto Endo, Kanagawa (JP); Fumio Matsui, Tokyo (JP); Yoshitaka Hatano, Tokyo (JP)

Correspondence Address: SUGHRUE MION, PLLC, 2100 Pennsylvania Avenue, N.W., Washington, DC, 20037-3213, US

(73) Assignee: SHOW A DENKO K.K.

(21) Appl. No.: 10/033,208

(22) Filed: Jan. 2, 2002

Related U.S. Application Data
(60) Provisional application No. 60/258,873, filed on Jan. 2, 2001.

(30) Foreign Application Priority Data
Sep. 11, 2000 (JP) P2000-274868

(51) Int. Cl. H01M 8/02; H01B 1/24; H01B 1/12

(52) U.S. Cl. 429/34; 252/511

(57) ABSTRACT

An electrically conducting curable resin composition containing (A) a vinyl ester resin, (B) at least one monomer selected from an allyl ester monomer, an acrylic acid ester monomer or a methacrylic acid ester monomer, (C) a radical polymerization initiator and (D) at least 40% by mass of a carbonaceous filler, and a cured product thereof are disclosed. The electrically conducting curable resin composition and cured product thereof not only have high electrical conductivity, but also excellent heat radiation property, high heat resistance and good corrosion resistance, and therefore are suitable for use as a highly electrically conducting material such as separator for fuel cells.

### CROSS REFERENCE TO RELATED APPLICATIONS

This application is an application filed under 35 U.S.C. §111(a) claiming benefit pursuant to 35 U.S.C. §119(e)(1) of the filing date of Provisional Application 60/258,873 filed Jan. 2, 2001 pursuant to 35 U.S.C. §111(b).

### FIELD OF THE INVENTION

The present invention relates to a curable resin composition, more specifically, the present invention relates to a curable resin composition having excellent properties not only in electrical conductivity but also in heat radiation, heat resistance and corrosion resistance. The present invention also relates to a cured product thereof.

### BACKGROUND OF THE INVENTION

Recently, with remarkable innovation in technologies including the electronic industry, there has been rapid progress on the technique of supportive materials therefor. Similarly, with respect to the development of polymer materials, a large number of novel or high-performance polymer materials and the application thereof have been newly developed.

In the electronic field, the properties demanded for the polymer material are mainly formability, heat resistance, durability, electric characteristics (e.g., high insulation, high electrical conductivity), corrosion resistance, heat radiation and the like, though these vary depending on the final product or end use. For example, heat- or photo-curable resins represented by epoxy resin and phenol resin, and thermoplastic resins including various engineering plastics represented by polyimide, polycarbonate, polyphenylene oxide and liquid crystal polymer, are known to satisfy the above-described requirements to a certain extent and are used in practice.

The demand for a material totally fulfilling those various capabilities is of course large but this is obstructed by great difficulty from some technical aspects or by disadvantageous results in view of the cost. One of the technical problems to be solved is the development of a polymer material having high electrical conductivity and at the same time having heat radiation property, heat resistance and corrosion resistance. The development of such a material is an object of the present invention.

Many investigations have been heretofore made on a highly electrically conducting material comprising a carbonaceous filler and a heat curable resin. For example, JP-B-50-11355 (the term “JP-B” as used herein means an “examined Japanese patent publication”) and JP-A-59-213610 (the term “JP-A” as used herein means an “unexamined published Japanese patent application”) disclose a combination of graphite and phenol resin. However, the use of phenol resin not only causes a problem in productivity because a long curing time is required during production, but also is disadvantageous in that low molecular matters are gasified and thereby liberated during the curing and bubbles are generated in the molded article. As such, the above-described combination is characteristically disadvantageous in some uses in the electronic field.

On the other hand, when an unsaturated polyester resin is used as the base resin, the resulting combination not only has an unavoidable problem in that the alkali resistance is poor, but also is often in need of improvements in pressure cooker resistance (an endurance test, for example, with saturated water vapor at 121° C. and 2 atm).

### SUMMARY OF THE INVENTION

An object of the present invention is to provide a curable resin composition having excellent electrical conductivity and at the same time, having excellent heat radiation property, heat resistance and corrosion resistance. Another object of the present invention includes providing a cured product thereof.

Under these circumstances, the present inventors have made extensive investigations to develop a curable resin composition, using a vinyl ester resin and a carbonaceous filler as main starting materials, capable of providing a cured product having excellent electrical conductivity and exhibiting heat radiation property, heat resistance and corrosion resistance. As a result, a curable resin composition achieving an object of the present invention has been accomplished.

More specifically, the present invention provides an electrically conducting curable resin composition comprising (A) a vinyl ester resin, (B) at least one monomer selected from the group consisting of an allyl ester monomer, an acrylic acid ester monomer and a methacrylic acid ester monomer, (C) a radical polymerization initiator and (D) at least 40% by mass (based on the total mass of (A)+(B)+(C)+(D)) of a carbonaceous filler, and also provides a cured product thereof.

### BRIEF DESCRIPTION OF THE DRAWINGS

FIG. 1 is a schematic plan view of a thin plate prepared later for trial in the Examples.

FIG. 2 is a schematic front view of the thin plate shown in FIG. 1.

### DETAILED DESCRIPTION OF THE INVENTION

The present invention is described in detail below, by referring to the drawings. Unless otherwise indicated herein, the “parts” and “%” indicate a quantitative proportion by mass.

The vinyl ester resin (A) for use in the present invention is not particularly limited, but examples thereof include those obtained by reacting a glycidyl ether of bisphenol A with an acrylic acid or a methacrylic acid. Specific examples of the vinyl ester resin which can be suitably used in the present invention include novolak-type vinyl ester resin. This resin can be produced starting from a novolak-type glycidyl ether.

In the curable resin composition of the present invention, the vinyl ester resin (A) is preferably contained in a proportion of 3 to 50% by mass, more preferably from 8 to 40% by mass, and still more preferably from 10 to 30% by mass, based on the total mass (100% by mass) of (A)+(B)+(C)+(D).

The allyl ester monomer (B) for use in the present invention is not particularly limited, but examples thereof include diallyl phthalate and diallyl cyclohexane-dicarboxylate. Among these, diallyl phthalate is preferred.

The (meth)acrylic acid ester monomer, which is another embodiment of (B), is not particularly limited, but specific examples thereof include phenoxyethyl methacrylate, isobornyl methacrylate, benzyl methacrylate, dicyclo-pentenyloxyethyl (meth)acrylate, trimethylolpropane di(meth)acrylate, trimethylolpropane tri(meth)acrylate, trimethylolpropane tris-oxy(meth)acrylate, pentaerythritol tetra(meth)acrylate, glycerin di(meth)acrylate and 1,6-hexanediol diacrylate. Furthermore, in order to impart flame resistance, a halogen substituted compound of these monomers may also be used.

In the curable resin composition of the present invention, at least one monomer (B) selected from the group consisting of an allyl ester monomer, an acrylic acid ester monomer and a methacrylic acid ester monomer is preferably contained in a proportion of 0.5 to 40% by mass, more preferably from 2 to 20% by mass, and still more preferably from 2.5 to 10% by mass, based on the total mass (100% by mass) of (A)+(B)+(C)+(D).

The radical polymerization initiator (C) for use in the present invention is not particularly limited. Examples of this component include an organic peroxide and a photopolymerization initiator but in the present invention, an organic peroxide is more preferred.

The organic peroxide may be a known organic peroxide such as dialkyl peroxide, acyl peroxide, hydroperoxide, ketone peroxide and peroxy ester. Specific examples thereof include benzoyl peroxide, tert-butylperoxy-2-ethylhexanoate, 2,5-dimethyl-2,5-di(2-ethylhexanoyl)peroxyhexane, tert-butyl peroxybenzoate, tert-butyl hydroperoxide, cumene hydroperoxide, dicumyl peroxide, di-tert-butyl peroxide and 2,5-dimethyl-2,5-dibutylperoxyhexane.

Examples of the photopolymerization initiator include 2,2-dimethoxy-1,2-diphenylethan-1-one, 1-hydroxycyclohexyl phenyl ketone, benzophenone, 2-methyl-1-(4-methyl-thiophenyl)-2-morpholinopropane-1,2-benzyl-2-dimethylamino-1-(4-morph olinophenyl)-butanone-1,2-hydroxy-2-methyl-1-phenylpropan-1-one and 2,4,6-trimethylbenzoyldiphenyl-phosphine oxide.

These radical polymerization initiators (C) may be used individually or in combination of two or more thereof. In the curable resin composition of the present invention, the proportion of the radical polymerization initiator (C) blended is preferably from 0.05 to 10% by mass, and more preferably from 0.1 to 5% by mass (based on the total mass of (A)+(B)+(C)+(D)).

The carbonaceous filler (D) for use in the present invention is not particularly limited but examples thereof include carbon black (e.g., ketjen black, acetylene black, furnace black, oil furnace black), artificial graphite, natural graphite (e.g., kish graphite, decomposable graphite), carbon fiber, carbon short fiber, glassy carbon and a combination or composite of two or more thereof. Among these, graphite is preferred. In the curable resin composition of the present invention, the carbonaceous filler (D) is contained in a proportion of at least 40% by mass, preferably from 50 to 95% by mass, more preferably from 60 to 90% by mass, and still more preferably from 65 to 85% by mass (based on the total mass of (A)+(B)+(C)+(D)).

The graphite is preferably produced at a calcination temperature of 2,500° C. or more, preferably 2,700° C. or more, and more preferably 2,900° C. or more. The average particle size of the graphite is preferably from 3 to 200 μm, and more preferably from 5 to 100 μm (particularly from 5 to 80 μm). This average particle size can be determined, for example, as follows.

The average particle size can be determined by a laser diffraction scattering method. More specifically, 50 mg of a sample is weighed and added to 50 ml of distilled water, 0.2 ml of an aqueous solution of 2% Triton (surfactant) is added, the resulting solution is dispersed using an ultrasonic wave for 3 minutes, and the particle size is measured by a Microtrack HRA apparatus manufactured by Nikkiso K.K.

If desired, artificial graphite can be used as the main component by blending it with natural graphite.

In the present invention, the aspect ratio of graphite is preferably 5 or less, more preferably 3.5 or less, and still more preferably 2.0 or less.

With respect to the combination of the aspect ratio and the average particle size of graphite, a graphite having an aspect ratio of 5 or less and an average particle size of 5 to 100 μm is preferred, and a graphite having an aspect ratio of 3.5 or less (particularly 2.0 or less) and an average particle size of 5 to 80 μm is more preferred.

Depending on the use end of the curable resin composition or the cured product, it is preferable to use graphite as the main component and structure the entire carbonaceous filler by a combination or composite system with carbon black and/or carbon short fiber (preferably with carbon short fiber). In such an embodiment, assuming that the entire carbonaceous filler is 100% by mass, at most 40% by mass (more preferably at most 20% by mass) of carbon black and/or carbon short fiber is preferably used.

Examples of the carbon short fiber include middle carbon fiber, vapor grown carbon fiber and carbon nanotube. From the standpoint of improving the electrical and mechanical properties, the carbon short fiber is more preferably vapor grown carbon fiber having a fiber diameter of 0.05 to 10 μm and a fiber length of 1 μm to 5 mm and/or carbon nanotube having a fiber diameter of 0.005 to 5 μm and a fiber length of 1 to 100 μm.

The aspect ratio is a ratio of a long diameter to a short diameter of a particle and as the aspect ratio is larger, the particle shape is more flat. The minimum aspect ratio is 1 and this means that the particle is a ball or a spherical polyhedron. In the present invention, the aspect ratio is measured using a scanning electron microscopic method. More specifically, the appearance of a fine particle is photographed by a scanning electron microscope, a long diameter and a short diameter of individual particles are measured on about 300 particles, and an arithmetic mean thereof is determined.

Generally, the aspect ratio of graphite is around 50 in the case of normal natural graphite and on the order of 6 to 12 in the case of a pulverized product of artificial graphite. Such flat particles having a large aspect ratio may not satisfy the demanded level depending on the use, shape of molded article or required electrical conductivity. For example, these particles may be deficient in the formability represented by a filling or flowing property into a vinyl ester resin and provide a molded article failing in increasing in the density or increased in the air permeability.

The process for producing the curable resin composition of the present invention is not particularly limited but, for example, the above-described respective components are preferably mixed as uniformly as possible using a mixer commonly used in the field of resin, such as roll, kneader, Banbury mixer, Henschel mixer, planetary mixer and extruder. At the time of curing the curable resin composition, a radical polymerization initiator is preferably added and mixed after all components excluding the radical polymerization initiator are uniformly mixed. If desired, after all components excluding a radical polymerization initiator and a carbonaceous filler are uniformly mixed, and a radical polymerization initiator is then added and uniformly mixed, a carbonaceous filler may be added and mixed.

The obtained heat curable resin composition can be formed into a shape of powder, granule, pellet, tablet, sheet or the like and then subjected to a final molding step.

Although the molding method is not particularly limited, the curable resin composition of the present invention can be formed into a desired shape using a generally known molding method such as injection molding, transfer molding or press molding (including compression molding) and at the same time, can be cured by radicals generated from the polymerization initiator upon heat or irradiation of high energy line. With respect to the conditions during heat curing, it is important to select and search for an optimal temperature according to the kind of the radical polymerization initiator used. For example, in the case of a molded article having a thickness of 4 mm, when dicumyl peroxide is used, complete curing can be attained through curing at 150° C. for 3 minutes, unmolding and after-curing at 170° C. for 1 hour.

Also, a curing process of holding the molded article in the mold, for example, at 175° C. for 3 minutes, thereby completing the curing to such an extent that the after-curing can be omitted, may be used.

The electrically conducting cured product of the present invention preferably has the following properties. That is, the volume resistivity is preferably 1.0 Ωcm or less, more preferably 1.0×10⁻¹ Ωcm or less and particularly for use as a separator for fuel cells, the volume resistivity is suitably 5×10⁻² Ωcm or less, more suitably 9×10⁻³ Ωcm or less.

The heat conductivity is preferably 1.0 W/m·K or more, more preferably 4.0 W/m·K or more, and still more preferably 7.0 W/m·K or more. The air permeability, which is a particularly important characteristic value for a separator for fuel cells, is preferably 1×10⁻⁵ cm²/sec or less, more preferably 1×10⁻⁶ cm²/sec or less, and still more preferably 1×10⁻⁷ cm²/sec or less.

Other than the above-described additives, the curable resin composition of the present invention may contain, if desired, additives such as ultraviolet stabilizer, antioxidant, defoaming agent, leveling agent, mold-releasing agent and water repellent to improve hardness, durability, weather resistance, water resistance and the like.

The curable resin composition of the present invention exhibits good processability and workability even in an embodiment containing no organic solvent. This is a very valuable point when taking into account the recent trend of attaching much importance to the safety of workers and conservation of global environment. Of course, the curable resin composition of the present invention can be more improved in flowability with the addition of a solvent to have more elevated mold processability. In such an embodiment of adding an organic solvent to the curable resin composition of the present invention, the amount of the organic solvent added is preferably 20% by mass or less, more preferably 10% by mass or less, and still more preferably 5% by mass or less, per 100% by mass of solid contents in the curable resin composition of the present invention.

At the actual mold-processing site, the curable resin composition of the present invention can be stably stored at an ordinary temperature (room temperature) for a long period of time until the composition is subjected to a processing step, and this is one of the characteristic features not available in conventional condensation reaction-type heat curable resin compositions such as epoxy resin and phenol resin.

The curable resin composition of the present invention has very high practicability because the materials constituting the composition are easily available in a large amount. Furthermore, the cured product thereof has properties, such as electrical conductivity and heat radiation property (e.g., heat resistance, corrosion resistance, molding precision). Therefore, the curable resin composition is useful in various ways in the electronic field or as various parts of electrical appliances, machines and vehicles. In particular, the use of the curable resin composition as a raw material of a separator for fuel cells is a suitable example of one of the uses.

### EXAMPLES

The present invention is described in greater detail below by referring to the Examples, however, the present invention should not be construed as being limited thereto.

In the Examples, the measuring methods described below were used.

The air permeability is a value measured at a temperature of 23° C. under 1 atm of helium gas (an average value of 5 samples). This air permeability measuring method is described in detail, for example, in JIS K7126 (Method A).

The volume resistivity was determined by a four-probe volume resistivity measuring method according to JIS K7194.

The bending strength and the bending modulus were determined by measuring a specimen (80×10×4 mm) using a three-point bending strength measuring method according to JIS K6911 under conditions such that the span interval was 64 mm and the bending speed was 2.5 mm/min.

The mold shrinkage percentage was determined according to JIS K6911 (curing shrinkage percentage).

The specific gravity was determined according to Method A (underwater substitution method) of JIS K7112.

The heat conductivity was determined using QTM-500 manufactured by Kyoto Denshi Sha and evaluated according to the following four-stage criteria. At this time, the conditions shown below were used.

| | |
|---|---|
| Excellent: | 7 W/mK or more |
| Good: | 4 W/mK to less than 7 W/mK |
| Allowable: | 1 W/mK to less than 4 W/mK |
| Bad: | less than 1 W/mK |

Conditions

probe: PD-11, measuring method: comparison method,

23° C. and 50% RH

The materials used in Examples are shown below.

Component (A):

A-1: novolak-type vinyl ester resin (Ripoxy SP-5070 produced by Showa Highpolymer Co., Ltd.)

A-2: novolak-type vinyl ester resin (Ripoxy SP-4010 produced by Showa Highpolymer Co., Ltd.)

A-3 (for comparison): phenol resin (BL-274 produced by Showa Highpolymer Co., Ltd.; viscosity at 25° C.: 3.2×10⁴ CPS (3.2×10⁴ mPa·s))

Component (B):

B-1: trimethylolpropanetrisoxyethylene methacrylate

B-2: benzyl methacrylate

B-3: diallyl terephthalate

B-4 (for comparison): styrene monomer

Component (C):

C-1: Percumyl D (dicumyl peroxide) produced by NOF Corporation

C-2: Perbutyl Z (tert-butyl peroxybenzoate) produced by NOF Corporation

C-3 (for comparison): 25% aqueous solution of sodium hydroxide

Component (D):

D-1: artificial graphite (SHOKARIZER, trade name) produced by Showa Denko K.K. was ground by a grinder Atomizer (manufactured by Fuji Paudal Co., Ltd.), milled by Marumerizer (manufactured by Fuji Paudal Co., Ltd.) and then classified, and the obtained graphite powder having the following properties was used.

| | |
|---|---|
| average aspect ratio: | 2.8 |
| average particle: | 80 μm |
| fixed carbon (by a testing method for coal | 99.8% |
| (technical analysis method), see, | |
| Encyclopaedia Chimica, Vol. 5, page 303, | |
| Kyoritsu Shuppan (1963)): | |

D-2: artificial graphite powder (UFG, trade name) produced by Showa Denko K.K. as a crude raw material was ground in the same manner as D-1 above using a grinder and a mill and then classified and the obtained graphite powder having the following properties was used.

| | |
|---|---|
| average aspect ratio: | 3.7 |
| average particle size: | 10 μm |
| fixed carbon: | 99.8% |

D-3: artificial graphite powder (SHOKARAIZER, trade name) produced by Showa Denko K.K.

| | |
|---|---|
| average aspect ratio: | 3.8 |
| average particle size: | 50 μm |
| fixed carbon: | 99.9% |

D-4: vapor grown carbon fiber (VGCF, trade name) produced by Showa Denko K.K.

| fiber diameter: | 0.1 to 0.5 μm |
|---|---|
| (average fiber diameter: 0.15 μm) | |
| fiber length: | 1 to 100 μm |

(average fiber length: 15 μm)

### Example 1

Respective components shown below were blended while kneading at 40° C. for 45 minutes using a kneader (MIXLAB, trade name, manufactured by Moriyama Seisakusho, rotational speed: 40 rpm) to obtain a resin composition. The obtained resin composition was not changed in the properties thereof even after storage at 23° C. and 50% RH for 3 months and was verified to have excellent storage stability.

| | | |
|---|---|---|
| Resin A-2: | 77 | parts by mass (12.8% by mass) |
| Monomer B-1: | 23 | parts by mass (3.8% by mass) |
| Initiator C-2: | 1.5 | parts by mass (0.3% by mass) |
| Graphite D-1: | 500 | parts by mass (83.1% by mass) |

Furthermore, 0.05 parts by mass of hydroquinone was added as a polymerization inhibitor based on the total amount of the resin composition. (This addition is not described for individual cases, but in the following resin compositions, hydroquinone as a polymerization inhibitor was added in the same manner).

Then, the obtained resin composition was cured by applying a pressure (30 MPa) under heat (150° C.) for 5 minutes in a compression molding machine (KOATSU-PRESS, trade name, manufactured by Shoji Tekko Sha) to form a resin sheet having a thickness of 3 mm. At this time, the curing shrinkage percentage was 0.165%.

From the thus-obtained resin sheet, a specimen was manufactured and various physical property values were measured. The results obtained are shown below.

| | |
|---|---|
| Specific gravity: | 2.02 (−) |
| Volume resistivity: | 4 m Ω cm |
| Bending strength: | 28 MPa |
| Bending modulus: | 1.15 × 10⁴ MPa |
| Heat conductivity: | Excellent |

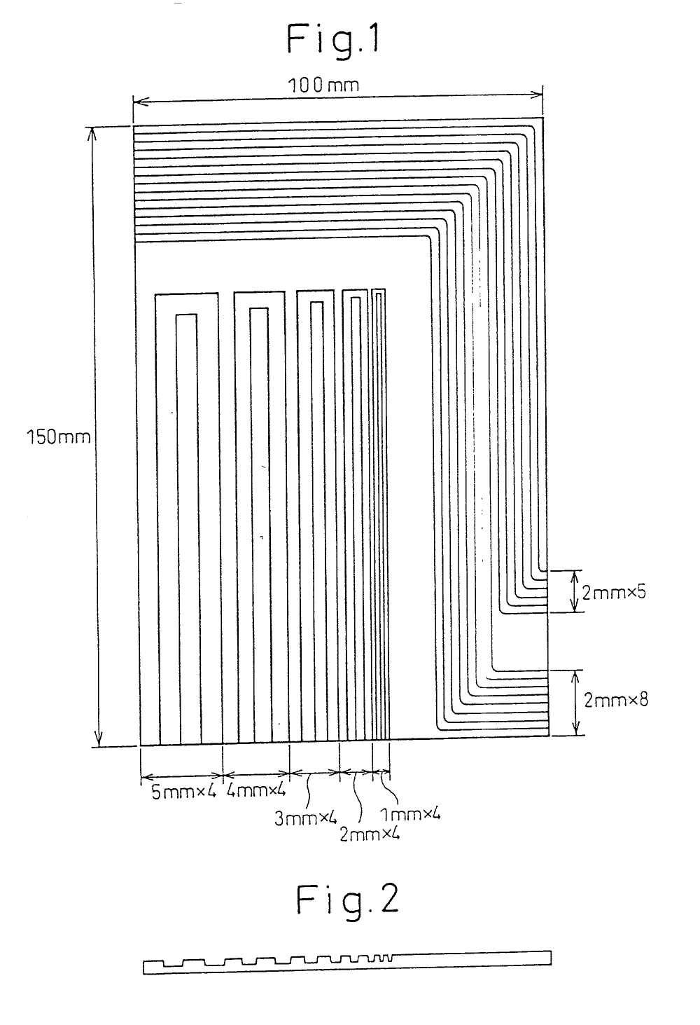

Using the curable resin composition obtained above, a thin plate having a maximum thickness of 2.0 mm, a minimum thickness of 1.0 mm and a groove depth of 1.0 mm, as shown in the schematic plan view of FIG. 1 and in the schematic cross-sectional view of FIG. 2, was manufactured for trial (compression molding). The curing conditions were 150° C. for 5 minutes and after-cure was not performed. The obtained thin plate had the properties shown below, revealing that the properties required for a separator for fuel cells were fully satisfied.

| | |
|---|---|
| Specific gravity: | 2.00 (−) |
| Volume resistivity: | 5 m Ω cm |
| Air permeability: | 1 × 10⁻⁸ cm²/sec |

### Example 2

Respective components shown below were blended in the same manner as in Example 1 to obtain a resin composition. The obtained resin composition was not changed in the properties thereof even after storage at 23° C. and 50% RH for 3 months and was verified to have excellent storage stability.

| | | |
|---|---|---|
| Resin A-2: | 77 | parts by mass (12.8% by mass) |
| Monomer B-1: | 23 | parts by mass (3.8% by mass) |
| Initiator C-2: | 1.5 | parts by mass (0.3% by mass) |
| Graphite D-2: | 500 | parts by mass (83.1% by mass) |

Then, the obtained resin composition was cured in the same manner as in Example 1 to form a resin sheet. At this time, the curing shrinkage percentage was 0.160%.

From the thus-obtained resin sheet, a specimen was manufactured and various physical property values were measured. The results obtained are shown below.

| | |
|---|---|
| Specific gravity: | 2.01 (−) |
| Volume resistivity: | 6 m Ω cm |
| Bending strength: | 34 MPa |
| Bending modulus: | 1.2 × 10⁴ MPa |
| Heat conductivity: | Excellent |

Using the curable resin composition obtained above, a thin plate (see FIG. 1) was manufactured for trial in the same manner as in Example 1 and the properties thereof were measured. The results obtained are shown below, revealing that the properties required for a separator for fuel cells were fully satisfied.

| | |
|---|---|
| Specific gravity: | 2.00 (−) |
| Volume resistivity: | 7 mΩcm |
| Air permeability: | 2 × 10⁻⁸ cm²/sec |

### Example 3

Using a universal mixing agitator (ACM, trade name, manufactured by Aikoh-Sha Seisakusho) having a mechanism of making autorotation or revolution of a stirring blade, respective components shown below were mixed for 45 minutes while stirring at a high speed (300 rpm) by taking care to always maintain the powder state at 40° C., to obtain a granular compound resin composition. The obtained resin composition was not changed in the properties thereof even after storage at 23° C. and 50% RH for 3 months and was verified to have sufficiently high storage stability.

| | | |
|---|---|---|
| Resin A-2: | 77 | parts by mass (12.8% by mass) |
| Monomer B-1: | 23 | parts by mass (3.8% by mass) |
| Initiator C-2: | 1.5 | parts by mass (0.3% by mass) |
| Graphite D-1: | 500 | parts by mass (83.1% by mass) |

Then, the obtained resin composition was cured in the same manner as in Example 1 to form a resin sheet. At this time, the curing shrinkage percentage was 0.166%. From the thus-obtained resin sheet, a specimen was manufactured and various physical property values were measured. The results obtained are shown below.

| | |
|---|---|
| Specific gravity: | 2.00 (−) |
| Volume resistivity: | 6 mΩcm |
| Bending strength: | 26 MPa |
| Bending modulus: | 1.0 × 10⁴ MPa |
| Heat conductivity: | Excellent |

Using the curable resin composition obtained above, a thin plate (see FIG. 1) was manufactured for trial in the same manner as in Example 1 and the properties thereof were measured. The results obtained are shown below, revealing that the properties required for a separator for fuel cells were fully satisfied.

| | |
|---|---|
| Specific gravity: | 2.00 (−) |
| Volume resistivity: | 6 mΩcm |
| Air permeability: | 3 × 10⁻⁸ cm²/sec |

### Example 4

Respective components shown below were blended in the same manner as in Example 1 to obtain a resin composition. The obtained resin composition was not changed in the properties thereof even after storage at 23° C. and 50% RH for 3 months and was verified to have excellent storage stability.

| | | |
|---|---|---|
| Resin A-2: | 77 | parts by mass (9.6% by mass) |
| Monomer B-1: | 23 | parts by mass (2.9% by mass) |
| Initiator C-2: | 1.5 | parts by mass (0.2% by mass) |
| Graphite D-1: | 700 | parts by mass (87.3% by mass) |

Then, the obtained resin composition was cured in the same manner as in Example 1 to form a resin sheet. At this time, the curing shrinkage percentage was 0.100%. From the thus-obtained resin sheet, a specimen was manufactured and various physical property values were measured. The results obtained are shown below.

| | |
|---|---|
| Specific gravity: | 2.06 (−) |
| Volume resistivity: | 2 mΩcm |
| Bending strength: | 30 MPa |
| Bending modulus: | 1.2 × 10⁴ MPa |
| Heat conductivity: | Excellent |

Using the curable resin composition obtained above, a thin plate (see FIG. 1) was manufactured for trial in the same manner as in Example 1 and the properties were measured. The results obtained are shown below, revealing that the properties required for a separator for fuel cells were fully satisfied.

| | |
|---|---|
| Specific gravity: | 2.04 (−) |
| Volume resistivity: | 3 mΩcm |
| Air permeability: | 1 × 10⁻⁸ cm²/sec |

### Example 5

Using respective components shown below, a resin composition was obtained in the same manner as in Example 1. The obtained resin composition was not changed in the properties thereof even after storage at 23° C. and 50% RH for 3 months and was verified to have excellent storage stability.

| | | |
|---|---|---|
| Resin A-2: | 77 | parts by mass (19.2% by mass) |
| Monomer B-1: | 23 | parts by mass (5.7% by mass) |
| Initiator C-2: | 1.5 | parts by mass (0.4% by mass) |
| Graphite D-1: | 300 | parts by mass (74.7% by mass) |

Then, the obtained resin composition was cured in the same manner as in Example 1 to form a resin sheet. At this time, the curing shrinkage percentage was 0.412%. From the thus-obtained resin sheet, a specimen was manufactured and various physical property values were measured. The results obtained are shown below.

| | |
|---|---|
| Specific gravity: | 1.94 (−) |
| Volume resistivity: | 10 mΩcm |
| Bending strength: | 28 MPa |
| Bending modulus: | 9.0 × 10³ MPa |
| Heat conductivity: | Excellent |

From the resin composition obtained above, a thin plate (see FIG. 1) was manufactured for trial in the same manner as in Example 1 except that the curing conditions were changed to 140° C. and 2 minutes. The obtained thin plate was found to have the properties shown below, revealing that the properties required for a separator for fuel cells were fully satisfied.

| | |
|---|---|
| Specific gravity: | 1.92 (−) |
| Volume resistivity: | 12 mΩcm |
| Air permeability: | 1 × 10⁻⁹ cm²/sec |

### Example 6

Using respective components shown below, a resin composition was obtained in the same manner as in Example 1. The obtained resin composition was not changed in the properties thereof even after storage at 23° C. and 50% RH for 3 months and was verified to have excellent storage stability.

| | | |
|---|---|---|
| Resin A-1: | 77 | parts by mass (12.8% by mass) |
| Monomer B-2: | 23 | parts by mass (3.8% by mass) |
| Initiator C-1: | 1.5 | parts by mass (0.3% by mass) |
| Graphite D-1: | 500 | parts by mass (83.1% by mass) |

Then, the obtained resin composition was cured in the same manner as in Example 1 to form a resin sheet except that the curing conditions were changed to 170° C. and 3 minutes. At this time, the curing shrinkage percentage was 0.170%. From the thus-obtained resin sheet, a specimen was manufactured and various physical property values were measured. The results obtained are shown below.

| | |
|---|---|
| Specific gravity: | 2.03 (−) |
| Volume resistivity: | 4 m Ω cm |
| Bending strength: | 31 MPa |
| Bending modulus: | 1.3 × 10⁴ MPa |
| Heat conductivity: | Excellent |

From the resin composition obtained above, a thin plate (see FIG. 1) was manufactured for trial in the same manner as in Example 1 except that the curing conditions were changed to 170° C. and 4 minutes. The obtained thin plate was found to have the properties shown below, revealing that the properties required for a separator for fuel cells were fully satisfied.

| | |
|---|---|
| Specific gravity: | 2.01 (−) |
| Volume resistivity: | 5 m Ω cm |
| Air permeability: | 2 × 10⁻⁸ cm²/sec |

### Example 7

Using respective components shown below, a resin composition was obtained in the same manner as in Example 1. The obtained resin composition was not changed in the properties thereof even after storage at 23° C. and 50% RH for 3 months and was verified to have excellent storage stability.

| | | |
|---|---|---|
| Resin A-1: | 77 | parts by mass (12.8% by mass) |
| Monomer B-3: | 23 | parts by mass (3.8% by mass) |
| Initiator C-1: | 1.5 | parts by mass (0.3% by mass) |
| Graphite D-1: | 500 | parts by mass (83.1% by mass) |

Then, the obtained resin composition was cured in the same manner as in Example 1 to form a resin sheet except that the curing conditions were changed to 160° C. and 5 minutes. At this time, the curing shrinkage percentage was 0.171%. From the thus-obtained resin sheet, a specimen was manufactured and various physical property values were measured. The results obtained are shown below.

| | |
|---|---|
| Specific gravity: | 2.04 (−) |
| Volume resistivity: | 3 m Ω cm |
| Bending strength: | 29 MPa |
| Bending modulus: | 1.3 × 10⁴ MPa |
| Heat conductivity: | Excellent |

From the resin composition obtained above, a thin plate (see FIG. 1) was manufactured for trial in the same manner as in Example 1 except that the curing conditions were changed to 120° C. and 5 minutes. The obtained thin plate had the properties shown below, revealing that the properties required for a separator for fuel cells were fully satisfied.

| | |
|---|---|
| Specific gravity: | 2.02 (−) |
| Volume resistivity: | 5 m Ω cm |
| Air permeability: | 9 × 10⁻⁹ cm²/sec |

### Example 8

Using respective components shown below, a resin composition was obtained in the same manner as in Example 1. The obtained resin composition was not changed in the properties thereof even after storage at 23° C. and 50% RH for 3 months and was verified to have excellent storage stability.

| | | |
|---|---|---|
| Resin A-2: | 77 | parts by mass (12.8% by mass) |
| Monomer B-1: | 23 | parts by mass (3.8% by mass) |
| Initiator C-2: | 1.5 | parts by mass (0.3% by mass) |
| Graphite D-1: | 150 | parts by mass (24.9% by mass) |
| Graphite D-2: | 200 | parts by mass (33.3% by mass) |
| Graphite D-3: | 150 | parts by mass (24.9% by mass) |

Then, the obtained resin composition was cured in the same manner as in Example 1 to form a resin sheet. At this time, the curing shrinkage percentage was 0.164%. From the thus-obtained resin sheet, a specimen was manufactured and various physical property values were measured. The results obtained are shown below.

| | |
|---|---|
| Specific gravity: | 2.03 (−) |
| Volume resistivity: | 4 m Ω cm |
| Bending strength: | 31 MPa |
| Bending modulus: | 1.3 × 10⁴ MPa |
| Heat conductivity: | Excellent |

From the resin composition obtained above, a thin plate (see FIG. 1) was manufactured for trial in the same manner as in Example 1 except that the curing conditions were changed to 160° C. and 3 minutes. The obtained thin plate was found to have the properties shown below, revealing that the properties required for a separator for fuel cells were fully satisfied.

| | |
|---|---|
| Specific gravity: | 2.01 (−) |
| Volume resistivity: | 5 m Ω cm |
| Air permeability: | 2 × 10⁻¹⁰ cm²/sec |

### Example 9

Using respective components shown below, a resin composition was obtained in the same manner as in Example 1. The obtained resin composition was not changed in the properties thereof even after storage at 23° C. and 50% RH for 3 months and was verified to have excellent storage stability.

| | | |
|---|---|---|
| Resin A-2: | 77 | parts by mass (12.8% by mass) |
| Monomer B-1: | 23 | parts by mass (3.8% by mass) |
| Initiator C-2: | 1.5 | parts by mass (0.3% by mass) |
| Graphite D-1: | 450 | parts by mass (74.79% by mass) |

Carbon Short Fiber D-4: 50 parts by mass (8.31% by mass)

Then, the obtained resin composition was cured in the same manner as in Example 1 to form a resin sheet. At this time, the curing shrinkage percentage was 0.10%.

From the thus-obtained resin sheet, a specimen was manufactured and various physical property values were measured. The results obtained are shown below.

| | | |
|---|---|---|
| Specific gravity: | 2.02 | (-) |
| Volume resistivity: | 3 | mΩcm |
| Bending strength: | 40 | MPa |
| Bending modulus: | 1.6 × 10⁴ | MPa |

| | |
|---|---|
| Heat conductivity: | Excellent |

Also, a thin plate was manufactured for trial in the same manner as in Example 1 and measured on the properties thereof. The results obtained are shown below, revealing that the properties required for a separator for fuel cells were fully satisfied by this thin plate.

| | | |
|---|---|---|
| Specific gravity: | 2.00 | (-) |
| Volume resistivity: | 5 | mΩcm |
| Air permeability: | 2 × 10⁸ | cm²/sec |

### Comparative Example 1

Using respective components shown below, a resin composition was obtained in the same manner as in Example 1. The obtained resin composition had a problem in storability due to severe odor and vigorous volatilization of the monomer. As a result, the practicability was poor. More specifically, after storage at 5° C. for 2 days, the composition was reduced in mass and could not be used.

| | | | | |
|---|---|---|---|---|
| Resin A-2: | 77 | parts by mass | (12.8% | by mass) |
| Monomer B-4: | 23 | parts by mass | (3.8% | by mass) |
| Initiator C-2: | 1.5 | parts by mass | (0.3% | by mass) |
| Graphite D-2: | 500 | parts by mass | (83.1% | by mass) |

Then, the obtained resin composition was cured in the same manner as in Example 1 to form a resin sheet. At the preparation of the curable composition and at the time of compression molding, the odor was very strong and the working environment was bad.

### Comparative Example 2

Using respective components shown below, a resin composition was obtained in the same manner as in Example 1. The obtained resin composition was not changed in the properties thereof even after storage at 23° C. and 50% RH for 3 months and was verified to have excellent storage stability.

| | | | | |
|---|---|---|---|---|
| Resin A-2: | 77 | parts by mass | (47.7% | by mass) |
| Monomer B-1: | 23 | parts by mass | (14.2% | by mass) |
| Initiator C-2: | 1.5 | parts by mass | (0.9% | by mass) |
| Graphite D-2: | 60 | parts by mass | (37.1% | by mass) |

Then, the obtained resin composition was cured in the same manner as in Example 1 to form a resin sheet. At this time, the curing shrinkage percentage was 1.14%. From the thus-obtained resin sheet, a specimen was manufactured and various physical property values were measured. The results obtained are shown below.

| | | |
|---|---|---|
| Specific gravity: | 1.47 | (-) |
| Volume resistivity: | 17 | mΩcm |
| Bending strength: | 26 | MPa |
| Bending modulus: | 5.2 × 10³ | MPa |
| Air permeability: | 2 × 10⁷ | cm²/sec |

| | |
|---|---|
| Heat conductivity: | Bad |

Since the volume resistivity was large and the heat conductivity was small, this sheet was not suitable as a material for uses intended by the present invention.

### Comparative Example 3

Respective components shown below were blended while kneading at an ordinary temperature to obtain a resin composition. The obtained resin composition was formed into sheets. The sheets were blocked (stuck to each other) only after storage at 5° C. and 50% RH for one month. Therefore, the resin composition was found to have seriously deficient storage stability.

| | | | | |
|---|---|---|---|---|
| Resin A-3: | 77 | parts by mass | (12.8% | by mass) |
| Monomer B-1: | 23 | parts by mass | (3.8% | by mass) |
| C-3: | 0.4 | parts by mass | (0.1% | by mass) |
| Graphite D-2: | 500 | parts by mass | (83.3% | by mass) |

Then, the obtained resin composition was cured in the same manner as in Example 1 to form a resin sheet except that the curing conditions were changed to 160° C. and 60 minutes. At this time, the curing shrinkage percentage was 0.313%. From the thus-obtained resin sheet, a specimen was manufactured and various physical property values were measured. The results obtained are shown below.

| | | |
|---|---|---|
| Specific gravity: | 1.95 | (-) |
| Volume resistivity: | 20 | mΩcm |
| Bending strength: | 22 | MPa |
| Bending modulus: | 9.5 × 10³ | MPa |

| | |
|---|---|
| Heat conductivity: | Excellent |

From the resin composition obtained above, a thin plate (see FIG. 1) was manufactured for trial in the same manner as in Example 1 except that the curing conditions were changed to 160° C. and 60 minutes. The obtained thin plate had the properties shown below.

| | | |
|---|---|---|
| Specific gravity: | 1.90 | (-) |
| Volume resistivity: | 34 | mΩcm |

Air permeability:
large dispersion from 1 × 10⁴ to 3 × 10⁶ cm²/sec

The obtained thin plate had bad air permeability and deficient molding stability, the curable composition was poor in storability and the curing thereof took a very long time. Thus, the composition and cured product were revealed to be unsuitable for uses in the field intended by the present invention.

The curable resin composition of the present invention forms a cured product having excellent electrical conductivity and also having high heat resistance, excellent heat radiation property and good corrosion resistance. Therefore, the curable resin composition of the present invention can be widely applied to technological fields where an intended material has been heretofore difficult to realize, such as in the electronic field or in various uses and parts of electrical appliances, machines and vehicles. In particular, the curable resin composition of the present invention is very useful as a raw material of a separator for solid fuel cells.

While the invention has been described in detail and with reference to specific embodiments thereof, it will be apparent to one skilled in the art that various changes and modifications can be made therein without departing from the spirit and scope thereof.

What is claimed is:

1. An electrically conducting curable resin composition comprising (A) a vinyl ester resin, (B) at least one monomer selected from the group consisting of an allyl ester monomer, an acrylic acid ester monomer and a methacrylic acid ester monomer, (C) a radical polymerization initiator and (D) at least 40% by mass of a carbonaceous filler based on the total mass of (A)+(B)+(C)+(D).

2. The electrically conducting curable resin composition as claimed in claim 1, which comprises from 3 to 50% by mass of the component (A), from 0.5 to 40% by mass of the component (B), from 0.05 to 10% by mass of the component (C) and from 40 to 95% by mass of the component (D), based on the total mass of (A)+(B)+(C)+(D).

3. The electrically conducting curable resin composition as claimed in claim 1, wherein the vinyl ester resin (A) is a novolak vinyl ester resin.

4. The electrically conducting curable resin composition as claimed in claim 2, wherein the vinyl ester resin (A) is a novolak vinyl ester resin.

5. The electrically conducting curable resin composition as claimed in claim 1, wherein the component (B) is diallyl phthalate.

6. The electrically conducting curable resin composition as claimed in claim 2, wherein the component (B) is diallyl phthalate.

7. The electrically conducting curable resin composition as claimed in claim 1, wherein the radical polymerization initiator (C) is an organic peroxide or a photopolymerization initiator and the carbonaceous filler (D) comprises graphite.

8. The electrically conducting curable resin composition as claimed in claim 2, wherein the radical polymerization initiator (C) is an organic peroxide or a photopolymerization initiator and the carbonaceous filler (D) comprises graphite.

9. The electrically conducting curable resin composition as claimed in claim 1, wherein the carbonaceous filler (D) comprises graphite having an aspect ratio of 5 or less and an average particle diameter of 5 to 100 μm.

10. The electrically conducting curable resin composition as claimed in claim 2, wherein the carbonaceous filler (D) comprises graphite having an aspect ratio of 5 or less and an average particle diameter of 5 to 100 μm.

11. The electrically conducting curable resin composition as claimed in any one of claims 1 to 10, wherein the carbonaceous filler (D) comprises graphite having an aspect ratio of 5 or less and an average particle diameter of 5 to 100 μm and comprises vapor grown carbon fibers having a fiber diameter of 0.05 to 10 μm and a fiber length of 1 82 m to 5 mm and/or carbon nanotubes having a fiber diameter of 0.005 to 5 μm and a fiber length of 1 to 100 μm, in an amount of 40% by mass or less based on 100% by mass of carbonaceous filler (D).

12. An electrically conducting cured product obtained by curing the curable resin composition claimed in any one of claims 1 to 10.

13. An electrically conducting cured product obtained by curing the curable resin composition claimed in claim 11.

14. The electrically conducting cured product as claimed in claim 12, which has a volume resistivity of 1.0 Ωcm or less.

15. The electrically conducting cured product as claimed in claim 13, which has a volume resistivity of 1.0 Ωcm or less.

16. The electrically conducting cured product as claimed in claim 12, which has a heat conductivity is 1.0 W/m·K or more.

17. The electrically conducting cured product as claimed in claim 13, which has a heat conductivity is 1.0 W/m·K or more.

18. A separator for fuel cells comprising the electrically conducting cured product claimed in claim 14 and having a volume resistivity of 5×10⁻² Ωcm or less and an air permeability of 1×10⁻⁵ cm²/sec or less.

19. A separator for fuel cells comprising the electrically conducting cured product claimed in claim 15 and having a volume resistivity of 5×10⁻² Ωcm or less and an air permeability of 1×10⁻⁵ cm²/sec or less.

20. A separator for fuel cells comprising the electrically conducting cured product claimed in claim 16 and having a volume resistivity of 5×10⁻² Ωcm or less and an air permeability of 1×10⁻⁵ cm²/sec or less.

21. A separator for fuel cells comprising the electrically conducting cured product claimed in claim 17 and having a volume resistivity of 5×10⁻² Ωcm or less and an air permeability of 1×10⁻⁵ cm²/sec or less.
